(19) United States
(12) Patent Application Publication
(10) Pub. No.: US 2020/0290292 A1
(43) Pub. Date: Sep. 17, 2020

(54) METHOD OF USING ROLLED CONNECTING SYSTEMS FOR ADJACENT ENDS OF INSULATION TUBING

(71) Applicant: Aeroflex USA, Inc., Sweetwater, TN (US)

(72) Inventors: Brad Steverson, Lenior City, TN (US); Greg Ertel, Clinton, TN (US)

(73) Assignee: Aeroflex USA, Inc., Sweetwater, TN (US)

(21) Appl. No.: 16/890,244

(22) Filed: Jun. 2, 2020

Related U.S. Application Data
(62) Division of application No. 15/467,437, filed on Mar. 23, 2017.

(51) Int. Cl. B29C 65/00; F16L 59/16

(52) U.S. Cl. CPC B29C 66/01; B29L 2023/225; F16L 59/166

(57) ABSTRACT

A method of applying a pressure sensitive transfer adhesive to at least two end faces of insulation tubing, using a rolled connection system for adjacent ends of insulated tubing sections having a substrate roll of continuous release liner. Pressure sensitive transfer adhesive material members configured to conform with the ends of insulated tubing sections to be joined are spaced at selected distances from each other along the length of the continuous release liner. A second release liner covers each pressure sensitive adhesive material member and includes a tab to facilitate removal of the second release liner from the adhesive material members to facilitate joining juxtaposed face portion of the ends of the insulated tubing to be connected.

### CROSS-REFERENCE TO RELATED APPLICATIONS

This Application is a divisional of U.S. patent application Ser. No. 15/467,437, filed Mar. 23, 2017, the entire content of which is herein incorporated.

### BACKGROUND

### 1. Field of Invention

The present invention relates to systems and methods for joining adjacent ends of sections of insulation tubing.

### 2. Description of the Related Art

Insulation tubing is used for pipes and fittings that convey steam, hot materials, condensate, lubricants, cryogenic fluids and cold materials typically used in heating and air conditioning, power facilities, food processing facilities and petrochemical facilities. Thus, insulation tubing is used in a wide array of industrial applications, such as boilers and petrochemical plants, and for a variety of purposes, including, for example, condensation control and energy conservation (e.g., minimizing thermal leakage).

Insulation tubing generally is applied in sections to the exterior of the pipe before or after the pipe itself is joined. A problem arises of how to ensure a stable connection between two adjacent sections of insulation tubing placed around the exterior of the pipe.

For example, U.S. Pat. No. 6,902,784, issued to Princell et al., discloses a pressure-sensitive adhesive insulation structure for joining two adjacent insulation structures. The pressure-sensitive insulation comprises a carrier having a first side and second side. A pressure-sensitive adhesive is in communication with the first side and in communication with the second side for adhering an insulation structure, such as those used to insulate piping. When used for joining two adjacent insulation structures, the carrier remains in place between the adjacent insulation structures.

### SUMMARY

A method of applying a pressure sensitive transfer adhesive to at least two end faces of insulation tubing, using a rolled connection system for adjacent ends of insulated tubing sections having a substrate roll of continuous release liner. Pressure sensitive transfer adhesive material members configured to conform with the ends of insulated tubing sections to be joined are spaced at selected distances from each other along the length of the continuous release liner. A second release liner covers each pressure sensitive adhesive material member and includes a tab to facilitate removal of the second release liner from the adhesive material members to facilitate joining juxtaposed face portion of the ends of the insulated tubing to be connected.

In some aspects, the present general inventive concept includes a method of applying a pressure sensitive transfer adhesive to at least two end faces of insulation tubing, the method including fitting a first section of insulation tubing having at least one end face to a pipe; peeling a release liner from a continuous substrate roll by holding the substrate, holding a release liner tab of the release liner, and applying a force opposite the substrate to the release liner tab until an exposed pressure sensitive transfer adhesive material release liner detaches from the continuous substrate roll; contacting the at least one end face of the first section of insulation tubing with the pressure sensitive transfer adhesive material of the exposed pressure sensitive transfer adhesive material release liner; applying pressure to the release liner to adhere the exposed pressure sensitive transfer adhesive material to the at least one end face of the first section of insulation tubing; peeling the release liner from the pressure sensitive transfer adhesive material by holding the release liner tab and applying a force opposite the end face of the first section of insulation tubing to expose the pressure sensitive transfer adhesive material; and fitting a second section of insulation tubing having at least one end face to the pipe and contacting the at least one end face of the second section of insulation tubing with the pressure sensitive transfer adhesive material previously adhered to the first section of insulation tubing.

In some aspects, a method of applying a pressure sensitive transfer adhesive to at least two end faces of insulation tubing includes fitting a first section of insulation tubing having at least one end face to a pipe; peeling a pressure sensitive transfer adhesive member and attached release liner from a continuous substrate roll that includes multiple pressure sensitive transfer adhesive material members configured to conform with end faces of insulation tubing sections, said multiple pressure sensitive transfer adhesive material members being spaced at selected distances from each other along the continuous substrate roll's length, each said pressure sensitive transfer adhesive member being covered by a release liner, whereby peeling said pressure sensitive transfer adhesive member and attached release liner from said continuous substrate roll exposes one face of said pressure sensitive transfer adhesive member; contacting the at least one end face of the first section of insulation tubing with the exposed face of said pressure sensitive transfer adhesive material member; applying pressure to the release liner to adhere the exposed face of said pressure sensitive transfer adhesive material member to the at least one end face of the first section of insulation tubing; peeling the release liner from said pressure sensitive transfer adhesive material member; and fitting a second section of insulation tubing having at least one end face to the pipe and contacting the at least one end face of the second section of insulation tubing with the pressure sensitive transfer adhesive material member previously adhered to the first section of insulation tubing.

In some aspects, a method of applying a pressure sensitive transfer adhesive to at least two end faces of insulation tubing includes fitting a first section of insulation tubing having at least one end face to a pipe; peeling a pressure sensitive transfer adhesive member and attached release liner from a continuous substrate roll that includes at least three pressure sensitive transfer adhesive material members configured to conform with end faces of insulation tubing sections, said continuous substrate roll including a paper-based web and a release coating on the paper-based web, said pressure sensitive transfer adhesive material members being spaced at selected distances from each other along the continuous substrate roll's length, each said pressure sensitive transfer adhesive member being covered by a release liner, each said release liner including an inner concentric circle and an outer concentric circle, with the outer concentric circle including a release liner tab protruding tangentially from the outer concentric circle, whereby peeling said pressure sensitive transfer adhesive member and attached release liner from said continuous substrate roll exposes one face of said pressure sensitive transfer adhesive member; contacting the at least one end face of the first section of insulation tubing with the exposed face of said pressure sensitive transfer adhesive material member; applying pressure to the release liner to adhere the exposed face of said pressure sensitive transfer adhesive material member to the at least one end face of the first section of insulation tubing; peeling the release liner from said pressure sensitive transfer adhesive material member by holding the release liner tab and applying a force opposite the end face of the first section of insulation tubing to expose the pressure sensitive transfer adhesive material; and fitting a second section of insulation tubing having at least one end face to the pipe and contacting the at least one end face of the second section of insulation tubing with the pressure sensitive transfer adhesive material previously adhered to the first section of insulation tubing.

### BRIEF DESCRIPTION OF THE DRAWINGS

The invention is better understood with reference to the following drawings and description. The components in the figures are not necessarily to scale, emphasis instead being placed upon illustrating the principles of the invention.

FIG. 1A represents a continuous unperforated substrate roll including spaced pressure sensitive transfer adhesive material (“PSTAM”) each having a release liner;

FIG. 1A-1 represents a PSTAM removed from the roll and independent of its associated release liner;

FIG. 1A-2 represents a PSTAM including a reinforcement scrim;

FIG. 1B illustrates a continuous perforated substrate roll having release liners on each PSTAM;

FIG. 2 represents an interleaved stack of multiple release liners on spaced PSTAMs;

FIG. 3A, 3B and 3C show PSTAMs and associated release liners;

FIG. 4A represents an exposed PSTAM having been removed from the substrate and covered on one face with a release liner;

FIG. 4B represents the exposed PSTAM being attached with pressure to an end face of insulating tube;

FIG. 4C shows a release liner being pulled away from the PSTAM by the release liner tab;

FIG. 5 represents the face of a second of insulating tubing being pressed against the PSTAM adhering to the face of the first section of insulating tubing;

FIG. 6A represents an exposed PSTAM being attached with pressure to an end face of a section of insulating tubing;

FIG. 6B shows a release liner being removed in the direction of the arrows by the tab to leave the PSTAM exposed on the insulation tubing face;

FIG. 6C represents the PSTAM exposed on the first section of insulation tubing and ready for adhesion to the second section of tubing;

FIG. 6D represents an installer about to remove the release liner from the adhesive PSTAM with the assistance of the tab;

FIG. 6E represents an installer fitting a second section of insulation tubing around a continuous pipe; and

FIG. 6F represents the installer pressing the second section of tubing against the previously exposed PSTAM to form a continuously insulated pipe.

FIG. 7 represents a generally rectangular release liner tab.

### DETAILED DESCRIPTION

Continuous rolls of adhesive elements configured to join the faces of two congruent sections of insulation tubing around pipe are disclosed. The continuous rolls include multiple release liners with the associated pressure sensitive transfer material. The roll may be perforated to allow individual release liners or a subset of release liners with the associated pressure sensitive transfer material to be removed from the roll. The release liners include a tab to facilitate removal of the release liner from the adhesive before joining the faces of insulation tubing. The substrate of the roll may include a substrate tab to facilitate removal of the substrate from the adhesive before applying the adhesive to one face of the insulation tubing.

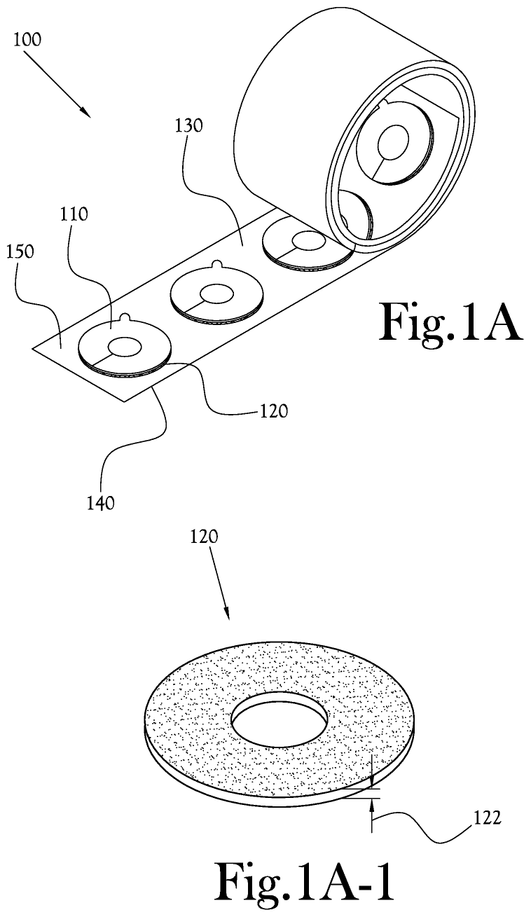

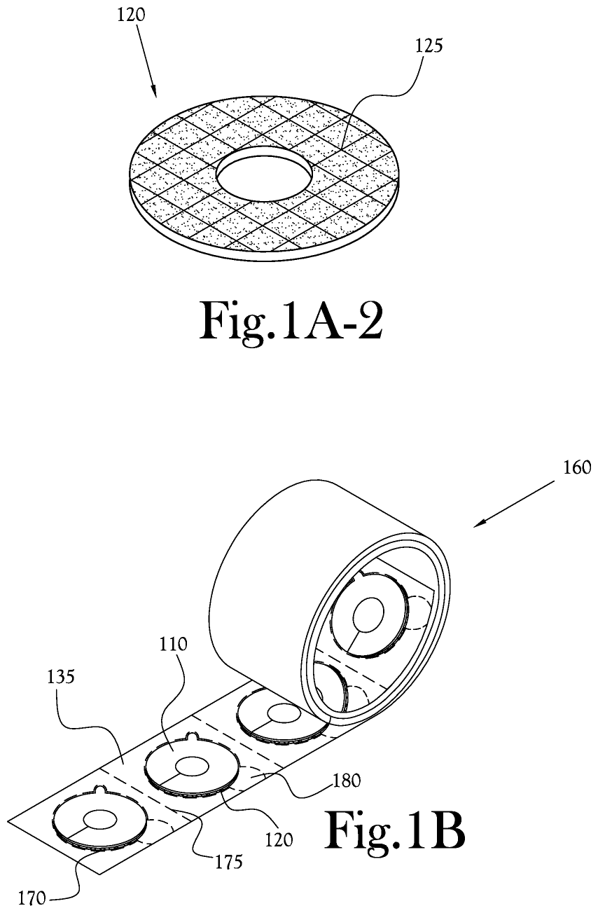

FIG. 1A represents a continuous unperforated substrate roll 100 including multiple release liners 110 on a pressure sensitive transfer adhesive material (“PSTAM”) 120. Thus, the multiple release liners 110 are on the PSTAM 120 and the PSTAM 120 is on the continuous unperforated substrate roll 130. The continuous unperforated substrate roll 130 is formed from a paper-based web 140 with a release coating 150 on the paper-based web 140 to facilitate release of the PSTAM 120. The web 140 may be a siliconized liner, and the like. The release coating 150 may be made from glassine and the like.

FIG. 1A-1 represents the PSTAM 120 independent from the release liners 110 and the substrate roll 130. The PSTAM 120 has a thickness 122 compatible with joining the desired insulation tubing. The thickness 122 of the PSTAM 120 may be from 0.038 to 0.13 mm., from 0.05 to 0.10 mm., from 0.06 to 0.09 mm., and from 0.07 to 0.08 mm., for example. Different thicknesses of the PSTAM 120 may be used based on the insulation tubing.

The PSTAM 120 is a pressure sensitive transfer adhesive that adheres to a surface that the adhesive is pressed against after contact. Thus, the PSTAM does not adhere or does not adhere well to a surface unless pressure is applied to “activate” the adhesive. The PSTAM 120 may be made from adhesives including acrylic-based, water emulsion acrylics, and the like. Other pressure sensitive transfer adhesives that release from the substrate roll 130 and the release liners 110, but adhere to the desired insulation tubing may be used as the PSTAM 120.

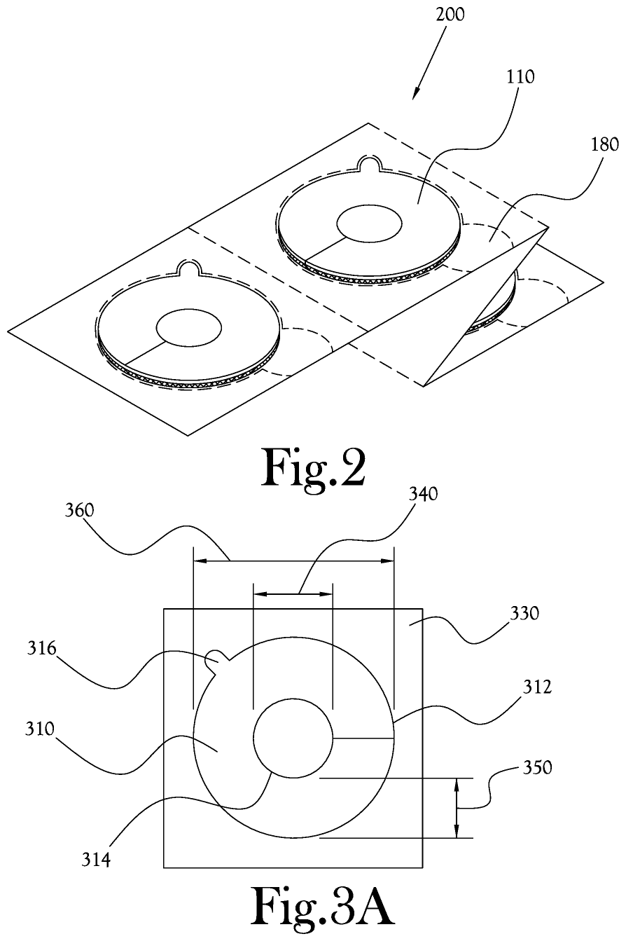

FIG. 1A-2 represents the PSTAM 120 as including a reinforcement scrim 125. The PSTAM 120 may include a “scrim” or open web of reinforcing threads. The reinforcement scrim 125 reinforces the physical structure of the PSTAM 120 to remain intact as a single body or layer during and after application between two adjacent sections of insulation tubing. The scrim may include a fine, lightweight material worked in a crisscrossed pattern internal to and surrounded by the adhesive material. Generally, the crisscrossed pattern of the scrim leaves substantial apertures allowing the free through-penetration of the adhesive material, while still providing structural reinforcement to maintain the adhesive material as a single body. While referred to as a “scrim”, the threads that form the reinforcement may be cotton, nylon, polyester, and other materials that provide the desired reinforcement to the PSTAM 120. The reinforcement function provided by the reinforcement scrim 125, also may be provided in forms other than by a thread, thus by a polymer having higher density and thus less flexibility than the polymer/s that form the adhesive material of the PSTAM 120, or by a glass filler, for example.

FIG. 1B represents a continuous perforated substrate roll 160 including the multiple release liners 110 on the PSTAM 120. Unlike the continuous unperforated substrate roll 100 of FIG. 1A, the perforated substrate roll 160 of FIG. 1B includes perforations 170 through perforated substrate 135 of the roll surrounding the multiple release liners 110. However, the perforations 170 do not completely surround the multiple release liners 110. Instead, the perforations 170 stop tracking the circumference of the multiple release liners 110 to form a substrate tab 180. While FIG. 1B represents the tangential protrusion angle of the substrate tab 180 at approximately 90° in relation to the perforation circumference, other tangential protrusion angles may be used for the substrate tab 180. The substrate tab 180 allows for each of the release liners 110, with the associated PSTAM 120 and perforated substrate 135, to be individually removed from the continuous perforated substrate roll 160. Thus, unlike for the continuous unperforated substrate roll 100 of FIG. 1A, the continuous perforated substrate roll 160 of FIG. 1B allows individual release liners 110 with the associated PSTAM 120 and the associated perforated substrate 135 to be removed and individually carried.

The continuous perforated substrate roll 160 also may have additional lateral perforations 175 through the perforated substrate 135 providing for a rectangular section of the perforated substrate 135 with the one or multiple release liners 110 to be separated from the continuous perforated substrate roll 160. In this way, one or more rectangular sections of the continuous perforated substrate roll 160 may be separated at the lateral perforations 175 and carried without the need to transport the continuous perforated substrate roll 160.

FIG. 2 represents an interleaved stack 200 of the multiple release liners 110. While FIG. 1A and FIG. 1B represent the multiple release liners 110 on continuous rolls 100, 160, the rolls can take the form of the interleaved stack 200. Thus, as used herein, the term “roll” also applies to an interleaved stack. In the case of the continuous unperforated substrate roll 100, creases may be placed in the substrate 130 to facilitate folding. In the case of the continuous perforated substrate roll 160 creases may be used if the continuous perforated substrate roll 160 lacks the additional lateral perforations 175. When the additional lateral perforations 175 are present, folding is facilitated along the additional lateral perforations 175.

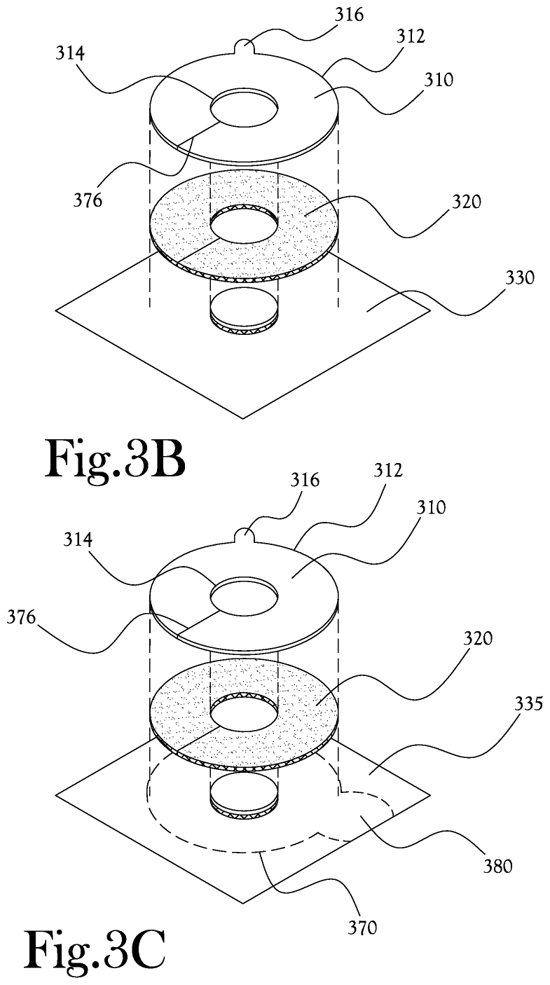

In FIG. 3A, FIG. 3B, and FIG. 3C each release liner 310, and thus the associated PSTAM 320, on which each of the release liners 310 resides, forms outer 312 and inner 314 concentric circles with a central opening, as commonly observed in a doughnut. The outer concentric circle 312 includes a release liner tab 316 protruding tangentially from the outer concentric circle 312 of the release liner 310. The release liner tab 316 may be formed from the same material that forms the release liner 310 or a separate part adhered, fused, and the like to the release liner 310. While FIG. 3A, FIG. 3B, and FIG. 3C represent the tangential protrusion angle of the release liner tab 316 as approximately 90°, other tangential protrusion angles may be used for the release liner tab 316. The PSTAM 320 may reside under the release liner tab 316, but the release liner tab 316 may not be on the PSTAM 320. In addition to rounded, the release liner tab 316 may take other shapes, such as generally rectangular release liner tab 716 of FIG.7. Other release liner tab shapes may be used that are consistent with pealing the release liner from the PSTAM.

In FIG. 3A, the inner concentric circle 314 of the release liner 310 has an inner diameter 340 that is slightly larger than the exterior diameter of the pipe to be insulated. While other inner concentric circle diameters may be used, inner concentric circle diameters that are slightly larger than 6 millimeters (mm.) to 105 mm. may be used. A distance 350 between the inner concentric circle 314 and an outer concentric circle diameter 360 of the release liner 310 determines the thickness of the insulation tubing that may be joined with the PSTAM 320 when released from the substrate 330, 335 and the associated release liner 310. While other outer concentric circle diameters may be used, outer concentric circle diameters from 12 mm. to 80 mm. may be used.

A cut 376 may be placed along the distance 350 through the release liner 310 and the PSTAM 320. Thus, the cut 376 may run from the outer concentric circle 312 to the inner concentric circle 314 of the release liner 310. While the cut 376 may extend through the substrate 330, 335, this is not required. The cut 376 allows for the release liner 310 and the associated PSTAM 320 when separated from the substrate 330, 335 to be placed around a pipe that is continuous, thus joined at both ends with other pipe. The cut 376 is used to slip the release liner 310 including the PSTAM 320 around the pipe to be insulated. If the cut 376 is omitted, the release liner 310 and the associated PSTAM 320 are configured for placement around pipes having at least one un-joined end.

When the release liner 310 is peeled from the substrate 330, 335 of the roll, the PSTAM 320 associated with the release liner 310 has a greater affinity for the release liner 310 than for the substrate 330, 335. Peeling is preferably facilitated by holding the substrate 330 or substrate tab 380 with a downward force while holding and applying an upward force to the release liner tab 316. Peeling the release liner 310 from the substrate 330, 335 breaks adhesion of the PSTAM 320 with the substrate 330, 335 to expose the face of the PSTAM 320 opposite the release liner 310.

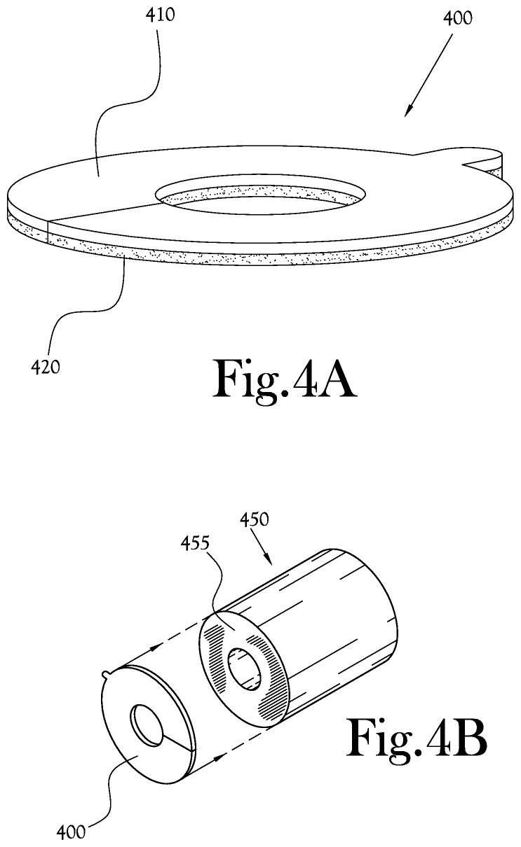

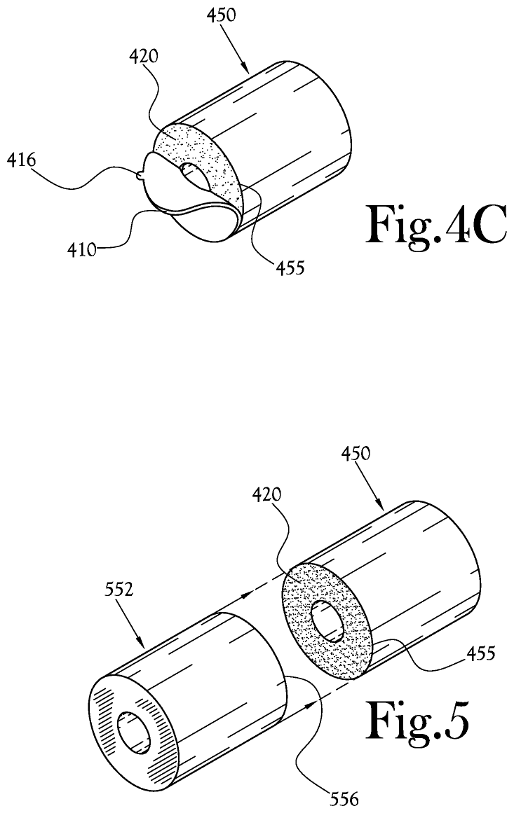

FIG. 4A represents an exposed PSTAM 400 that may be used to join adjacent ends of sections of insulation tubing. The exposed PSTAM release liner 400 includes a release liner 410 and an exposed PSTAM 420. FIG. 4B represents the exposed PSTAM release liner 400 being attached with pressure to an end face 455 of a first section of insulation tubing 450. FIG. 4C represents the release liner 410 being pulled away from the PSTAM 420 by release liner tab 416, so the PSTAM 420 remains adhered to the end face 455 of the first section of insulation tubing 450. Thus, after pressure is applied to the release liner 410, the PSTAM 420 has a greater affinity for the end face 455 of the first section of insulation tubing 450 than for the release liner 410.

FIG. 5 represents an end face 556 of a second section of insulation tubing 552 being pressed against the PSTAM 420 previously adhered to the end face 455 of the first section of insulation tubing 450. The pressure applied to the PSTAM 420 by the first and second sections of insulation tubing 450, 552 results in the end face 455 of the first section of insulation tubing 450 being adhered to the end face 556 of the second section of insulation tubing 552 by the PSTAM 420.

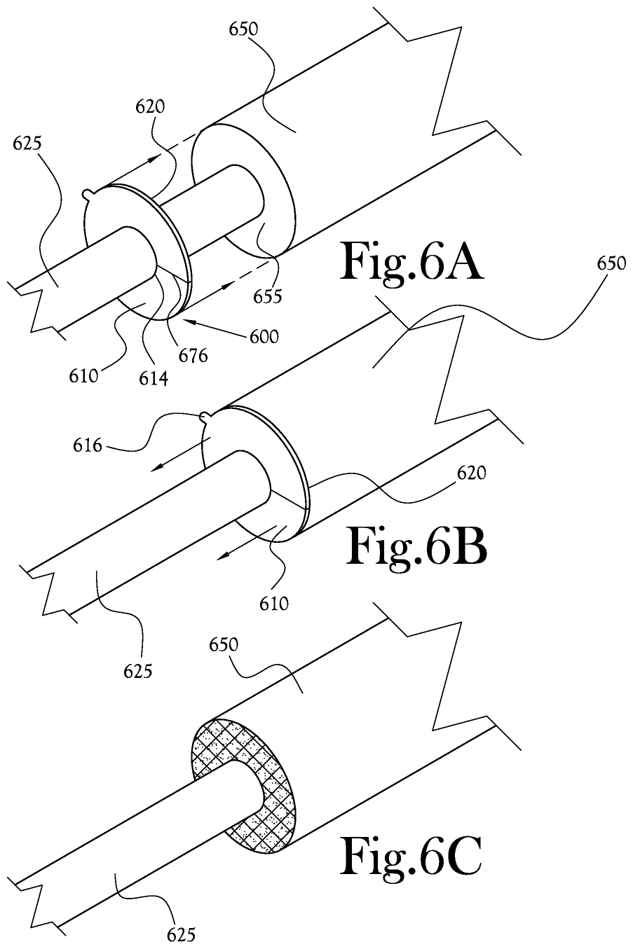

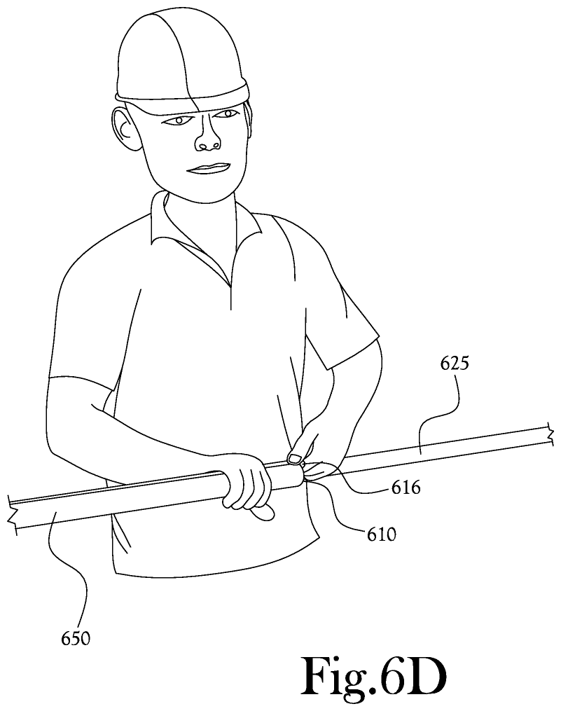

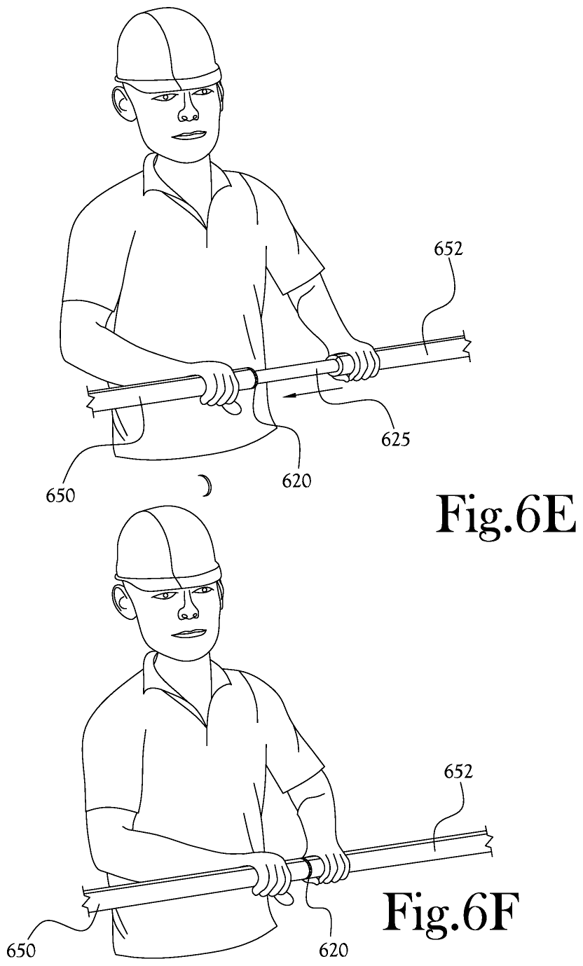

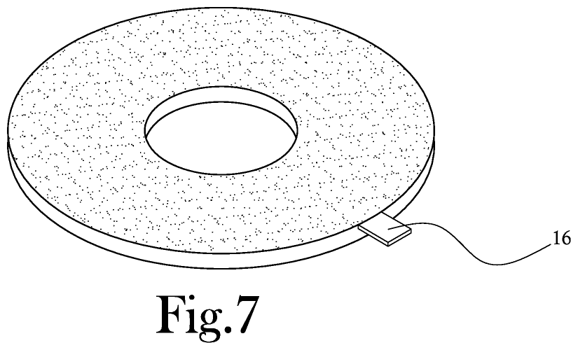

FIG. 6A represents an exposed PSTAM 600 being attached with pressure to an end face 655 of a first section of insulation tubing 650. The first section of insulation tubing 650 is placed around a continuous pipe 625. Unlike previously depicted with regard to FIG. 4B, as the continuous pipe 625 is being insulated in FIG. 6A, a cut 676 in the exposed PSTAM release liner 600 is used to place the exposed PSTAM release liner 600 around the continuous pipe 625. Pressure is applied to the release liner 610 so the exposed PSTAM 620 is adhered to the end face 655 of the first section of insulation tubing 650 and wraps around the exterior circumference of the continuous pipe 625. The inner concentric circle 614 of the exposed PSTAM release liner 600 uses the exterior circumference of the continuous pipe 625 as a positioning guide to press the exposed PSTAM release liner 600 against and contact the end face 655 of the first section of insulation tubing 650 and to adhere the PSTAM 620 to the end face 655 of the first section of insulation tubing 650.

FIG. 6B represents the release liner 610 being removed from the PSTAM 620 by the release liner tab 616 to leave the PSTAM 620 exposed on the end face 655 of the first section of insulation tubing 650. FIG. 6C represents the PSTAM 620 exposed on the end face 655 of the first section of insulation tubing 650, and thus ready for adhesion to a second section of insulation tubing (not shown).

FIG. 6D represents a human operator about to remove the release liner 610 from the adhered PSTAM 620 with the assistance of the release liner tab 616. FIG. 6E represents the human operator fitting a second section of insulation tubing 652 around the continuous pipe 625. The operator is about to adhere the second section of insulation tubing 652 to the previously exposed PSTAM 620 by moving the second section of insulation tubing 652 along the continuous pipe 625. FIG. 6F represents the human operator pressing the second section of insulation tubing 652 against the previously exposed PSTAM 620, which also is in contact with the first section of insulation tubing 650, to form a continuously insulated pipe. In this way, the first section of insulation tubing 650 and the second section of insulation tubing 652 are joined, with the PSTAM 620 between and adhering to both sections of insulation tubing.

To provide a clear and more consistent understanding of the specification and claims of this application, the following definitions are provided.

The term “on” is defined as “above” and is relative to the orientation being described. For example, if a first element is deposited over at least a portion of a second element, the first element is said to be “deposited on” the second. In another example, if a first element is present above at least a portion of a second element, the first element is said to be “on” the second. The use of the term “on” does not exclude the presence of substances between the upper and lower elements being described. For example, a first element may have a material over its top surface, yet a second element over at least a portion of the first element and its top material can be described as “on” the first element. Thus, the use of the term “on” may or may not mean that the two elements being related are in physical contact with each other.

While various aspects of the invention are described, it will be apparent to those of ordinary skill in the art that other embodiments and implementations are possible within the scope of the invention. Accordingly, the invention is not to be restricted except in light of the attached claims and their equivalents.

What is claimed is:

1. A method of applying a pressure sensitive transfer adhesive to at least two end faces of insulation tubing, the method comprising:
fitting a first section of insulation tubing having at least one end face to a pipe;
peeling a release liner from a continuous substrate roll by holding the substrate, holding a release liner tab of the release liner, and applying a force opposite the substrate to the release liner tab until an exposed pressure sensitive transfer adhesive material release liner detaches from the continuous substrate roll;
contacting the at least one end face of the first section of insulation tubing with the pressure sensitive transfer adhesive material of the exposed pressure sensitive transfer adhesive material release liner;
applying pressure to the release liner to adhere the exposed pressure sensitive transfer adhesive material to the at least one end face of the first section of insulation tubing;
peeling the release liner from the pressure sensitive transfer adhesive material by holding the release liner tab and applying a force opposite the end face of the first section of insulation tubing to expose the pressure sensitive transfer adhesive material; and
fitting a second section of insulation tubing having at least one end face to the pipe and contacting the at least one end face of the second section of insulation tubing with the pressure sensitive transfer adhesive material previously adhered to the first section of insulation tubing.

2. The method of claim 1, wherein each release liner includes an inner concentric circle and an outer concentric circle, wherein the outer concentric circle includes a release liner tab protruding tangentially from the outer concentric circle, wherein the continuous substrate roll includes a substrate tab proximate each release liner, and wherein the continuous substrate roll includes perforations through the substrate surrounding the outer concentric circle of each release liners, except where the perforations form a substrate tab.

3. The method of claim 1, further comprising placing the exposed pressure sensitive transfer adhesive material release liner around the pipe by opening a cut in the exposed pressure sensitive transfer adhesive material release liner.

4. A method of applying a pressure sensitive transfer adhesive to at least two end faces of insulation tubing, the method comprising:
fitting a first section of insulation tubing having at least one end face to a pipe;
peeling a pressure sensitive transfer adhesive member and attached release liner from a continuous substrate roll that includes multiple pressure sensitive transfer adhesive material members configured to conform with end faces of insulation tubing sections, said multiple pressure sensitive transfer adhesive material members being spaced at selected distances from each other along the continuous substrate roll's length, each said pressure sensitive transfer adhesive member being covered by a release liner, whereby peeling said pressure sensitive transfer adhesive member and attached release liner from said continuous substrate roll exposes one face of said pressure sensitive transfer adhesive member;
contacting the at least one end face of the first section of insulation tubing with the exposed face of said pressure sensitive transfer adhesive material member;
applying pressure to the release liner to adhere the exposed face of said pressure sensitive transfer adhesive material member to the at least one end face of the first section of insulation tubing;
peeling the release liner from said pressure sensitive transfer adhesive material member; and
fitting a second section of insulation tubing having at least one end face to the pipe and contacting the at least one end face of the second section of insulation tubing with the pressure sensitive transfer adhesive material member previously adhered to the first section of insulation tubing.

5. The method of claim 4 wherein said release liner attached to said pressure sensitive transfer adhesive material member further includes a release liner tab.

6. The method of claim 5 wherein the step of peeling a pressure sensitive transfer adhesive member and attached release liner from a continuous substrate roll comprises
holding the continuous substrate roll,
holding the release liner tab of the release liner, and
applying a force opposite the continuous substrate roll to the release liner tab until an exposed pressure sensitive transfer adhesive material release liner detaches from the continuous substrate roll.

7. The method of claim 5 wherein the step of peeling the release liner from said pressure sensitive transfer adhesive material member includes holding the release liner tab and applying a force opposite the end face of the first section of insulation tubing to expose the pressure sensitive transfer adhesive material.

8. The method of claim 4 wherein said continuous substrate roll further comprises lateral perforations through the continuous substrate roll between each of the multiple pressure sensitive transfer adhesive material members.

9. The method of claim 4 wherein said continuous substrate roll comprises an interleaved stack.

10. The method of claim 9 wherein said continuous substrate roll further comprises creases adapted to facilitate folding of said continuous substrate roll into an interleaved stack.

11. The method of claim 4 wherein the continuous substrate roll includes a paper-based web and a release coating on the paper-based web.

12. The method of claim 4 wherein the pressure sensitive transfer adhesive material includes a reinforcement scrim.

13. The method of claim 4 wherein the pressure sensitive transfer adhesive material is selected from the group consisting of an acrylic-based adhesive, a rubber-based adhesive, and combinations thereof.

14. The method of claim 4 wherein a thickness of the pressure sensitive transfer adhesive material is from 0.07 to 0.08 mm.

15. The method of claim 4 wherein each release liner includes an inner concentric circle and an outer concentric circle, and wherein the outer concentric circle includes a release liner tab protruding tangentially from the outer concentric circle.

16. A method of applying a pressure sensitive transfer adhesive to at least two end faces of insulation tubing, the method comprising:
fitting a first section of insulation tubing having at least one end face to a pipe;
peeling a pressure sensitive transfer adhesive member and attached release liner from a continuous substrate roll that includes at least three pressure sensitive transfer adhesive material members configured to conform with end faces of insulation tubing sections,
said continuous substrate roll including a paper-based web and a release coating on the paper-based web,
said pressure sensitive transfer adhesive material members being spaced at selected distances from each other along the continuous substrate roll's length,
each said pressure sensitive transfer adhesive member being covered by a release liner, each said release liner including an inner concentric circle and an outer concentric circle, with the outer concentric circle including a release liner tab protruding tangentially from the outer concentric circle, whereby peeling said pressure sensitive transfer adhesive member and attached release liner from said continuous substrate roll exposes one face of said pressure sensitive transfer adhesive member;
contacting the at least one end face of the first section of insulation tubing with the exposed face of said pressure sensitive transfer adhesive material member;
applying pressure to the release liner to adhere the exposed face of said pressure sensitive transfer adhesive material member to the at least one end face of the first section of insulation tubing;
peeling the release liner from said pressure sensitive transfer adhesive material member by holding the release liner tab and applying a force opposite the end face of the first section of insulation tubing to expose the pressure sensitive transfer adhesive material; and
fitting a second section of insulation tubing having at least one end face to the pipe and contacting the at least one end face of the second section of insulation tubing with the pressure sensitive transfer adhesive material previously adhered to the first section of insulation tubing.

17. The method of claim 16 wherein said continuous substrate roll further comprising lateral perforations through the continuous substrate roll between each of the multiple pressure sensitive transfer adhesive material members.

18. The method of claim 16 wherein said continuous substrate roll comprises an interleaved stack, and wherein said continuous substrate roll further comprises creases adapted to facilitate folding of said continuous substrate roll into an interleaved stack.

19. The method of claim 16, where the pressure sensitive transfer adhesive material includes a reinforcement scrim.

20. The method of claim 16, wherein the step of contacting the at least one end face of the first section of insulation tubing with the exposed face of said pressure sensitive transfer adhesive material member comprises placing the exposed pressure sensitive transfer adhesive material member around the pipe by opening a cut in the release liner.
